(19) United States
(12) Patent Application Publication
(10) Pub. No.: US 2012/0174936 A1
(43) Pub. Date: Jul. 12, 2012

(54) Methods for Increasing Mesopores into Microporous Carbon

(75) Inventors: Peter Branton, London (GB); Katsumi Kaneko, Chiba (JP); Lei Song, Fujiian (JP); Koki Urita, Nagasaki (JP)

(73) Assignee: British American Tobacco (Investments) LTD, London (GB)

(21) Appl. No.: 13/255,853

(22) PCT Filed: Mar. 10, 2010
(86) PCT No.: PCT/GB10/50426

§ 371 Date: Mar. 27, 2012

(30) Foreign Application Priority Data
Mar. 11, 2009 (GB) 0904196.3

(51) Int. Cl. A24D 3/16; C01B 31/10; C01B 31/08

(52) U.S. Cl. 131/331; 502/416

(57) ABSTRACT

The present invention provides a method for incorporating mesopores into microporous carbon, the method comprising treating granular microporous carbon with an alkaline earth metal salt such as calcium nitrate or an alkali metal salt. The present invention also provides mesoporous carbon produced using said method and smoking articles and smoke filters comprising said mesoporous carbon.

The present invention relates to methods for preparing mesoporous carbon materials, especially for use as adsorbents in smoking articles and smoke filters.

It is well known to incorporate porous carbon materials in smoking articles and smoke filters in order to reduce the level of certain materials in the smoke. Porous carbon materials may be produced in many different ways. The physical properties of porous carbon materials, including the shape and size of particles, the size distribution of the particles in a sample, the attrition rate of the particles, the pore size, the distribution of pore size and the surface area, all vary widely according to manner in which they have been produced. These variations significantly affect the performance or suitability of the material to perform as an adsorbent in different environments.

Generally, the larger the surface area of a porous material, the more effective it is in adsorption. Surface areas of porous materials are estimated by measuring the variation of the volume of nitrogen adsorbed by the material with partial pressure of nitrogen at a constant temperature. Analysis of the results by mathematical models originated by Brunauer, Emmett and Teller results in a value known as the BET surface area.

The distribution of pore sizes in a porous carbon material also affects its adsorption characteristics. In accordance with nomenclature used by those skilled in the art, pores in an adsorbent material are called “micropores” if their pore size is less than 2 nm (<2×10⁻⁹ m) in diameter, and “mesopores” if their pore size is in the range 2 to 50 nm. Pores are referred to as “macropores” if their pore size exceeds 50 nm Pores having diameters greater than 500 nm do not usually contribute significantly to the adsorbency of porous materials. For practical purposes therefore, pores having diameters in the range 50 nm to 500 nm, more typically 50 to 300 nm or 50 to 200 nm, can be classified as macropores.

The relative volumes of micropores, mesopores and macropores in a porous material can be estimated using well-known nitrogen adsorption and mercury porosimetry techniques. Mercury porosimetry can be used to estimate the volume of macro- and mesopores; nitrogen adsorption can be used to estimate the volumes of micro- and mesopores, using the so-called BJH mathematical model. However, since the theoretical bases for the estimations are different, the values obtained by the two methods cannot be compared directly with each other.

British Patent No. 2395650 compares the effect of a number of carbon materials having various micropore and mesopore volumes on the taste of tobacco smoke containing flavourings such as menthol. Carbon materials with a micropore volume of not greater than 0.3 cc/g and a mesopore volume of at least 0.25 cc/g are stated to adsorb less menthol than materials with different pore size distributions, and are therefore considered to be more suitable for use in a cigarette filter in flavoured cigarettes.

International Publication No. WO 03/059096 discloses cigarettes comprising a tobacco rod and a filter component having a cavity filled with beaded carbon of spherical form with diameters of from 0.2 to 0.7 mm, BET surface areas in the range 1000-1600 m²/g, and a pore size distribution predominantly in the range of micropores and small mesopores.

International Publication No. WO 2006/103404 discloses porous carbon material suitable for incorporation in smoke filters for cigarettes having a BET surface area of at least 800 m²/g and a pore structure that includes mesopores and micropores. The pore volume (as measured by nitrogen adsorption) is at least 0.9 cm³/g and from 15 to 65% of the pore volume is in mesopores. The pore structure of the material provides a bulk density generally less than 0.5 g/cc. The material may be produced by carbonising and activating organic resins.

Carbon materials may be treated in order to increase their surface areas by a process known as activation. Activated carbon may be produced by steam activation or chemical activation. For example, activation may be effected by heating carbon that has been treated with phosphoric acid or zinc chloride, or by heating carbon with steam or with carbon dioxide. Activation by carbon dioxide is sometimes followed by an additional air modification step, which involves heating the carbon in air. The activation process removes material from the inner surface of the carbon particles resulting in a reduction in weight, the weight loss being proportional to the period of the treatment.

Vegetable-based activated carbon, for example carbon from coconut shell, is now used in a significant and growing number of cigarette filters. In the case of coconut carbon, steam activation is preferred. The process of steam activation is preferably carried out in two stages. Firstly the coconut shell is converted into shell charcoal by carbonization process. The coconut shell charcoal is then activated by reaction with steam at a temperature of 900° C.-1100° C. under a controlled atmosphere. The reaction between steam and charcoal takes place at the internal surface area, creating more sites for adsorption. The temperature at which activation takes place is very important. Below 900° C. the reaction is too slow and is uneconomical. At a temperature above 1100° C., the reaction takes place on the outer surface of the charcoal resulting in loss of charcoal.

This activated coconut carbon has various beneficial properties which make it attractive for inclusion in cigarette filters. It includes a high level of micropores. However, it is desirable for adsorbents used in smoking articles to include increased levels of mesopores, in order to enhance their ability to adsorb materials from smoke.

It is therefore an object of the present invention to add mesopores to a vegetable-based microporous carbon in order to improve its adsorbent properties and performance in a cigarette filter. In particular, it is an object of the invention to provide mesoporous carbon which is more effective in removing constituents from cigarette smoke than conventional activated coconut carbon or equivalent adsorbent materials.

It is a further object of the present invention to provide a method for adding mesopores to porous carbon materials to provide adsorbents that are particularly effective in reducing one or more components from tobacco smoke. The method should be simple, cost-effective and produce reproducible results. It should be noted that there are only a few methods of introducing mesopores into vegetable or mineral-based carbon, such as coconut carbon.

According to a first aspect the present invention, there is provided a method for incorporating mesopores into microporous carbon, the method comprising treating the microporous carbon with an alkaline earth metal salt, such as calcium nitrate (Ca(NO₃)₂) or an alkali metal salt. The microporous carbon is preferably microporous coconut carbon, for example, microporous activated coconut carbon.

In one embodiment, the method of the invention comprises three steps. The first step involves dispersion of the alkaline earth metal salt or alkali metal salt on the microporous carbon. The second step involves adding mesopores by water vapour (steam) activation. The third step involves removal of the metal from the mesoporous carbon using an acid, such as hydrochloric acid.

In the first step, the alkaline earth metal salt or alkali metal salt is preferably dispersed on granular microporous carbon. In one embodiment, the carbon is immersed in a solution of the salt, optionally followed by vibration of the mixture for a period of time, such as between 1 and 24 hours. Following the immersion and vibration, the carbon is removed by filtration and dried.

In a specific embodiment, the alkaline earth metal salt solution comprises Ca(NO₃)₂. More specifically, a 2M solution of Ca(NO₃)₂ is added to granular microporous carbon. The mixture is then vibrated for up to 12 hours. The precise period of time for which the mixture is vibrated will depend upon the carbon used, but it will generally range from 2 to a maximum of 12 hours. The mixture is then filtered and dried without using distilled water.

The alkaline earth metal salt or alkali metal salt used in the methods of the invention is preferably soluble in water and is added to the granular carbon as a solution. Ca(NO₃)₂ is soluble in water, having a solubility of 121.2 g/100 ml at room temperature and this is probably beneficial to the method of the present invention. It is also safe, relatively inexpensive and gives excellent results, making it ideal for use in the methods of the present invention. CaCO₃ may be used although it has a poor solubility in water. Generally, alkaline earth metal salts and alkali metal salts providing hydroxide, carbonate and nitrate anions are preferred. Calcium is a good cation.

In the second step, activation to produce mesopores is carried out by exposing the granular carbon to water vapour. In an alternative embodiment, carbon dioxide may be used for activation. Preferably, argon is used as a carrier gas, whereby the argon gas is passed through water to generate water vapour. Alternative carrier gases include, for example, nitrogen. Activation is preferably carried out at a temperature in the range of about 800 to about 900° C., and more preferably at about 850° C. The ideal flow rate of the carrier gas will depend upon the amount of carbon being activated. For example, for 500 mg of carbon impregnated with Ca(NO₃)₂, a flow rate of at least 100 ml/min is proposed.

The flow rate of the gas and the temperature are selected to provide the granular carbon with the desired mesoporous properties. The period of time for which the carbon is activated will also have an effect on the properties of the resultant carbon and its adsorbent properties. The effect of the period of time for which the carbon undergoes the activation step is exemplified in Example 2 below. In a preferred embodiment, the activation is carried out for between 1 and 10 hours, more preferably for between 3 and 7 hours. The longer the activation period, the more mesopores are formed. However, it should be noted that activation for 10 hours or longer can result in the granular carbon losing its structural integrity and becoming powder. This is clearly undesirable and so, in one embodiment of the present invention, the activation step is carried out for no longer than 10 hours, and preferably for no longer than 9 hours.

In the third step, the activated granular carbon is treated to remove the metal, for example, the calcium if Ca(NO₃)₂ or CaCO₃ was used as the alkaline earth metal salt. This may be done using a solvent, for example an acid such as HCl. In one embodiment, a 1M HCl solution is used to wash the granular carbon for a period of 2 hours. The granular carbon is then filtered and dried.

Preferred properties of the resultant carbon material include, for example, (using IPAC definition of micropore, mesopore and macropore), a micropore volume of at least 0.4 cm³/g, a mesopore volume of at least 0.1 cm³/g and preferably at least 0.3 cm³/g, and a particle size range of from 250 to 1500 μm. Carbon particles having these properties exhibit excellent adsorption properties.

The starting material used in the method according to the present invention is preferably microporous vegetable-based carbon, such as microporous activated coconut carbon. This carbon is preferably in granular form. Activated coconut carbon is readily available and is widely used. It may be prepared by known processes for activating the natural carbon. For example, the granular coconut carbon may be treated at 383 K for 2 hours in vacuo in order to prepare a suitable starting material for the method of the invention. Alternatively, microporous activated coconut carbon may be purchased, for example from Jacobi Carbons.

The methods according to the invention will work using any activated carbon as the starting material. Preferred properties of the activated carbon starting material include: total pore volume of 0.1 to 0.8 cm³/g, mesopore volume of 0 to 0.4 cm³/g, micropore volume of 0.1 to 0.5 cm³/g, surface area (determined by BET) of 800 to 1200 m²/g, pore width of 0.5 to 0.8 nm and particle size of 30 to 60 mesh.

According to a second aspect the present invention there is provided mesoporous carbon produced using a method according to the first aspect of the invention. The mesoporous carbon is preferably vegetable-based.

Preferably, the methods according to the present invention result in a porous carbon material having a BET surface area of at least 800 m²/g, a density of not more than 0.5 g/cc, a pore structure that includes mesopores and micropores, and a pore volume (as measured by nitrogen adsorption) of at least 0.9 cm³/g.

The porous carbon materials produced according to the methods of the invention preferably have a bulk density less than 0.5 g/cc. Typical upper values for the range of densities of the carbon materials of the present invention are 0.45 g/cc, 0.40 g/cc, and 0.35 g/cc. Preferably, the bulk density of the carbon materials of the invention is in the range 0.5 to 0.2 g/cc.

The carbon materials of the invention may also be characterised by their pore structure rather than density.

Accordingly, mesoporous carbon according to the second aspect of the invention may have a BET surface area of at least 800 m²/g, a pore structure that includes mesopores and micropores, and a pore volume (as measured by nitrogen adsorption) of at least 0.9 cm³/g, from 15 to 65% of which is in mesopores.

The preferred porous carbon materials of the invention may be also be characterised by a pore structure wherein the pore volume (as measured by nitrogen adsorption) is at least 1.0 cm³/g, but less than 20% of the pore volume is in pores of from 2-10 nm. Usually less than 15%, and often less than 10% of the combined pore volume is in pores of from 2-10 nm.

The density and pore structure of porous carbon material are closely related. Generally, in samples of carbon materials prepared using the method according to the present invention, the higher the combined volume of micro-, meso- and macropores, the lower the density, because pores increase the volume of a given mass of material without increasing its weight. Furthermore, as the density decreases, so the proportion of macro- and mesopores to micropores increases. That is to say, in general, the lower the density of the carbon material of the invention, the higher the proportion of the pore volume in mesopores and macropores compared with the pore volume in micropores. However the correlation between density and pore volume, as determined by nitrogen adsorption, is not precise. Hence, some carbon materials of the invention having the pore structure defined in either of the two preceding paragraphs may have densities greater than 0.5 g/cc, for example densities of up to 0.52, 0.55, 0.60 or 0.65 g/cc. Conversely, some carbon materials of the invention may have densities less than 0.5 g/cc and a pore structure in which less than 15% (e.g. 12%, 10% or 5%) of the combined mesopore and micropore volume is in mesopores.

The lack of complete correlation between density and micro- and mesopore structure arises because the technique of nitrogen adsorption used to estimate pore size distribution is generally not used to measure pore sizes greater than about 50 nm. The total pore volume of a material estimated by nitrogen adsorption techniques therefore corresponds to the combined pore volumes of micropores and mesopores. The macropore volume of a material is not revealed by this technique. Thus, where the carbon materials of the invention have a low density and a relatively low proportion of mesopores, as detected by nitrogen adsorption, the low density is attributable to a relatively high pore volume in the macropore range immediately neighbouring mesopore range, i.e. in the range 50 nm to 500 nm. Whilst pore volumes in the macropore range can be estimated by mercury porosimetry, the results obtained using this technique do not match those obtained using nitrogen adsorption. Hence it is difficult to estimate precisely the pore volume of a material across the full range of pore sizes from 2-500 nm.

The BET surface area of the preferred porous carbon materials of the invention is at least 800 m²/g, preferably at least 900 m²/g, and desirably at least 1000 m²/g. Typical values for BET surface area of carbon materials of the invention are about 1000, 1100, 1150, 1200, 1250 and 1300 m²/g. Porous carbon materials with BET surface areas of up to 1250 m²/g, e.g. 1000-1250 m²/g, are most preferred.

The porous carbon materials of the invention preferably have a pore volume (as estimated by nitrogen adsorption) of at least 0.95 g/cc, and desirably at least 1 g/cc. Carbon materials with pore volumes of at least 1.1 cc/g are particularly useful as an adsorbent for tobacco smoke. Typical values for the pore volumes of the carbon materials of the invention are 1.15 cc/g, 1.2 cc/g, 1.25 cc/g and 1.3 cc/g. Usually, the combined pore volume will be in the range 1.1 to 2.0 cc/g. Carbon materials according to the invention with pore volumes significantly higher than 2.1 cc/g, for example 2.2 or 2.3 cc/g, are low in density and are therefore less easy to handle in cigarette production equipment. Such carbon materials are less favourable for use in cigarettes or smoke filters for that reason.

In the preferred carbon materials of the present invention, at least 30% but desirably no more than 65% of the pore volume (as estimated by nitrogen adsorption) is in mesopores. Typical minimum values for the volume of mesopores as a percentage of the combined micropore and mesopore volumes of the carbon materials of the invention are 35%, 40% or 45%. Typical maximum values for such volumes are 65%, 60% and 55%. Preferably the mesopore volume of the carbon materials of the invention is in the range 35-55% of the combined mesopore and micropore volume.

According to a third aspect of the present invention, there is provided a smoking article comprising smoking material and mesoporous carbon material produced using a method according to the first aspect of the present invention.

According to a fourth aspect of the present invention, there is provided a smoke filter comprising mesoporous carbon material produced using a method according to the first aspect of the present invention.

### EXAMPLE 1

Granular activated coconut carbon (0.5 ml/g micropore volume, 0 mesopore volume) was immersed in 100 ml Ca(NO₃)₂ solutions of 2 molL⁻¹ at room temperature for one day after pre-evacuation at 10 mPa and 383 K for 2 hours. Impregnated carbon was then obtained by drying at 383 K for one day. The impregnated carbon was steam-activated at 1123 K for 1 hour under argon flow at 400 mlmin⁻¹. The activated samples were soaked in the 1 molL⁻¹ hydrochloric acid solution, stirred for 4 hours, and then washed with deionized water to remove the residual chemical agent.

The nitrogen adsorption isotherms of the resultant carbon at 77 K show a hysteresis indicating the presence of mesopores. The pore volume of the added mesopores is 0.20 ml/g, being enough to influence adsorption characteristics for triacetin. The size of the mesopores added to the carbon was approximately 15 nm.

The pore structure parameters of the mesoporous carbon are as follows:
BET surface area (m²/g): 1200
Micropore volume (ml/g): 0.41
Mesopore volume (ml/g): 0.20
Average micropore width (nm): 0.72
Burn off (%): 27.5

Table 1 shows the smoke results comparing the mesoporous carbon according to the invention, prepared as set out in Example 1, with a control namely activated (microporous) coconut carbon. 60 mg of carbon was incorporated into the cavity filter design of a reference cigarette. As controls, 60 mg of commercially available microporous coconut carbon and an empty cavity were used. The percentage reductions are relative to the cigarette with an empty cavity (i.e. containing no carbon).

Smoking was performed under ISO conditions, i.e. a 35 cm³ volume puff of two second duration was taken every one minute. All experiments were conducted at 22° C. and 60% RH and the cigarettes were conditioned at 22° C. and 60% RH for three weeks prior to smoking.

TABLE 1

| % Reductions | Test 1 | Test 2 | Control carbon |
|---|---|---|---|
| Acetaldehyde | 30 | 35 | 27 |
| Acetone | 42 | 48 | 32 |
| Acrolein | 47 | 54 | 35 |
| Butyraldehyde | 37 | 47 | 30 |
| Crotonaldehyde | 40 | 53 | 35 |
| Formaldehyde | 37 | 36 | 26 |
| Methyl ethyl ketone | 40 | 50 | 33 |
| Propionaldehyde | 40 | 44 | 31 |
| HCN | 40 | 44 | 15 |
| 1,3-Butadiene | 52 | | 25 |
| Acrylonitrile | 56 | | 35 |
| Benzene | 60 | | 31 |
| Isoprene | 63 | | 35 |
| Toluene | 60 | | 26 |

From the data shown in Table 1 it is clear that the mesoporous carbon produced by a method according to the present invention is capable of providing a greater reduction in smoke constituents than the control carbon (microporous coconut carbon). The mesoporous carbon is therefore more effective as an adsorbent when included in a smoking article than the known activated carbon.

### EXAMPLE 2

10 g of granular coconut carbon was pretreated at 383 K for 2 hours in vacuo. Then, 1 g of the pretreated carbon was immersed in 10 ml of a 2M Ca(NO₃)₂ solution. The mixture was vibrated for 12 hours, following which it was filtered and dried.

500 mg samples of the carbon were then activated under argon and water vapour at 1123 K under argon flow of 100 mlmin⁻¹. The samples were activated for 1, 3, 5, 7 and 10 hours. The activated samples were then soaked in 50 ml of 1M hydrochloric acid solution for 2 hours. Finally, the samples were washed with deionised water, filtered and dried.

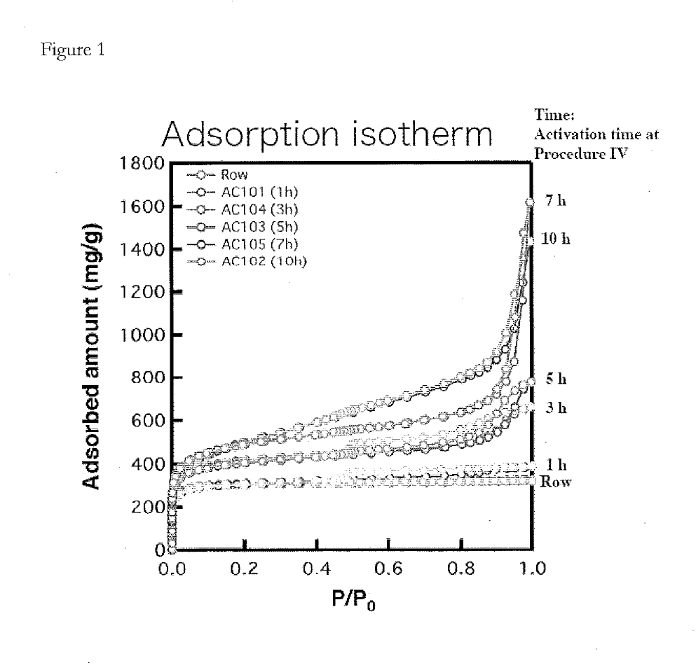

The nitrogen adsorption isotherms of the resultant carbon shown in FIG. 1 indicate that the presence of mesopores in the resultant carbon increased with the length of time for which the activation step was carried out. The inventors noted that the carbon obtained after activation of the pretreated carbon for 10 hours easily changed to powder, suggesting that it was unstable.

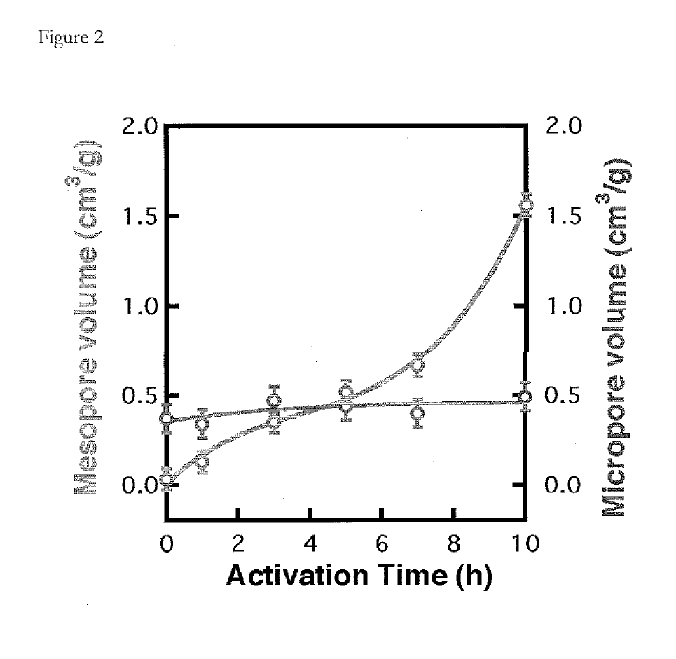

The changes in the micropores and mesopores of the carbon following activation for different lengths of time is shown in FIG. 2. The pore volumes shown in the graph were determined by αₛ-plot. This analysis requires a non-porous, chemically similar reference material and a disordered carbon black (404B) was used.

The structural properties of the activated carbon are shown in Table 2.

TABLE 2

| | Activation Time | | | | | |
|---|---|---|---|---|---|---|
| | 0 hours | 1 hour | 3 hours | 5 hours | 7 hours | 10 hours |
| Total pore | 0.40 | 0.48 | 0.82 | 0.96 | 1.07 | 2.05 |
| volume | | | | | | |
| (cm³/g) | | | | | | |
| Mesopore | 0.02 | 0.12 | 0.35 | 0.51 | 0.56 | 1.51 |
| volume | | | | | | |
| (cm³/g)* | | | | | | |
| Mesopore | 0.03 | 0.13 | 0.35 | 0.52 | 0.67 | 1.56 |
| volume | | | | | | |
| (cm³/g)** | | | | | | |
| Micropore | 0.37 | 0.36 | 0.47 | 0.45 | 0.51 | 0.54 |
| volume | | | | | | |
| (cm³/g)* | | | | | | |
| Micropore | 0.37 | 0.34 | 0.47 | 0.44 | 0.40 | 0.49 |
| volume | | | | | | |
| (cm³/g)** | | | | | | |
| S.S.A. | 975 | 955 | 1260 | 1224 | 1392 | 1436 |
| (m²/g) BET | | | | | | |
| S.S.A. | 988 | 938 | 1206 | 1166 | 1247 | 1328 |
| (m²/g) αₛ | | | | | | |
| Pore width | 0.77 | 0.82 | 0.88 | 0.88 | 1.26 | 0.96 |
| (nm) | | | | | | |

*determined by DR-plot
**determined by αₛ-plot
S.S.A. is the Specific Surface Area

The data in Table 2 indicates that the longer the impregnated carbon is activated for, the greater the mesopore volume. The method according to the present invention also leads to an increase in the micropore volume. The starting material has almost no mesopores.

Tables 3 and 4 show the results of an evaluation of the mesoporous coconut carbon produced in Example 2, with 60 mg of the mesoporous carbon included in the cavity of a cigarette. These smoke results were achieved using the same methodology as was used in Example 1.

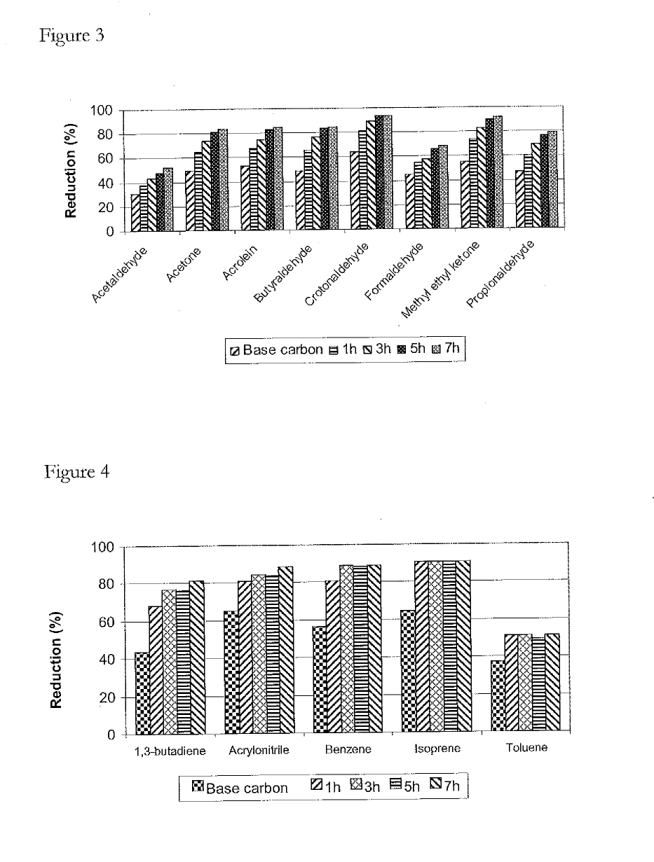

The data shown in Table 4 is also shown in FIGS. 3 and 4.

The data in Tables 3 and 4 indicates the adsorption of various chemicals by a control carbon, EcoSorb® CX, and by the carbon prepared according to the method of Example 2 and activated for 1, 3, 5 and 7 hours. EcoSorb® CX is a premium grade of coconut shell based activated carbon produced by Jacobi Carbons for use in the removal of organic compounds from the gaseous phase.

TABLE 3

| Measurement | Empty | Control | | | | |
|---|---|---|---|---|---|---|
| (μg/cig) | cavity | carbon | 1 hour | 3 hours | 5 hours | 7 hours |
| Acetaldehyde | 548 | 382 | 343 | 310 | 288 | 260 |
| Acetone | 270 | 137 | 95.4 | 70.1 | 49.9 | 43.4 |
| Acrolein | 68.4 | 32.25 | 21.9 | 17 | 11.7 | 10.6 |
| Acrylonitrile | 11.4 | 4.0 | 2.2 | 1.8 | 1.9 | 1.3* |
| Benzene | 35.7 | 15.5 | 6.8 | 4.0* | 4.2* | 4.0* |
| 1,3-Butadiene | 40.3 | 22.7 | 12.8 | 9.4 | 9.7 | 7.4 |
| Butyraldehyde | 36.1 | 18.7 | 12.2 | 8.57 | 5.94 | 5.42 |
| Crotonaldehyde | 20.4 | 7.31 | 3.87 | 2.17 | 1.28 | 1.21 |
| Formaldehyde | 61.05 | 33.7 | 27.6 | 25.6 | 20.8 | 19.1 |
| Isoprene | 225.6 | 80.4 | 21.2 | 20.8* | 21.6* | 20.9* |
| Methyl ethyl | 68 | 30.7 | 18 | 11.5 | 6.98 | 5.39 |
| ketone | | | | | | |
| Pro- | 45.7 | 24.15 | 18 | 13.9 | 10.6 | 9.38 |
| pionaldehyde | | | | | | |
| Toluene | 37.1 | 23.3 | 18.2* | 18.1* | 18.8* | 18.2* |

*Where the yields were less that the Limit of Quantification these values have been used and this is why the figures plateau for some analytes.

TABLE 4

| | Control | | | | |
|---|---|---|---|---|---|
| Reductions (%) | carbon | 1 hour | 3 hours | 5 hours | 7 hours |
| Acetaldehyde | 30 | 37 | 43 | 47 | 53 |
| Acetone | 49 | 65 | 74 | 82 | 84 |
| Acrolein | 53 | 68 | 75 | 83 | 85 |
| Acrylonitrile | 65 | 81 | 84 | 84 | 88* |
| Benzene | 57 | 81 | 89* | 88* | 89* |
| 1,3-Butadiene | 44 | 68 | 77 | 76 | 82 |
| Butyraldehyde | 48 | 66 | 76 | 84 | 85 |
| Crotonaldehyde | 64 | 81 | 89 | 94 | 94 |
| Formaldehyde | 45 | 55 | 58 | 66 | 69 |
| Isoprene | 64 | 91 | 91* | 90* | 91* |
| Methyl ethyl ketone | 55 | 74 | 83 | 90 | 92 |
| Propionaldehyde | 47 | 61 | 70 | 77 | 79 |
| Toluene | 37 | 51* | 51* | 49* | 51* |

*Reductions based upon the Limit of Quantification values.

From the data shown in Tables 3 and 4 it is clear that the mesoporous carbon produced by a method according to the present invention is capable of providing a greater reduction in smoke constituents than the control carbon (microporous coconut carbon). The mesoporous carbon is therefore more effective as an adsorbent when included in a smoking article than the known activated carbon.

The data in Tables 1, 3 and 4 indicate that the mesoporous carbon prepared according to the method of the present invention are suitable for use an adsorbents in smoking articles and smoke filters and that they are more effective at removing certain smoke constituents than the commonly used microporous coconut carbon.

1. A method for incorporating mesopores into microporous carbon, the method comprising treating granules of the microporous carbon with at least one of an alkaline earth metal salt and an alkali metal salt, wherein the microporous carbon is activated vegetable-based carbon.

2. The method as claimed in claim 1, wherein the microporous carbon is activated coconut carbon.

3. The method as claimed in claim 1, wherein the alkaline earth metal salt is calcium nitrate.

4. The method as claimed in claim 1, wherein the alkaline earth metal salt or alkali metal salt is dispersed on the microporous carbon by immersion of the carbon in a solution of the salt.

5. The method as claimed in claim 4, wherein the mixture of carbon and the solution of the salt is vibrated.

6. The method as claimed in claim 4, wherein the mixture of carbon and the solution of the salt is subsequently filtered and the carbon dried.

7. The method as claimed in claim 1, wherein the method comprises activating the microporous carbon treated with the salt.

8. The method as claimed in claim 7, wherein the activation is steam or water vapor activation.

9. The method as claimed in claim 8, wherein the activation is carried out under argon.

10. The method as claimed in claim 8, wherein the activation is carried out for a period of 1 to 10 hours.

11. The method as claimed in claim 7, wherein the activated carbon is treated to remove the metal.

12. The method as claimed in claim 11, wherein the carbon is washed with an acid to remove the metal.

12. The method as claimed in claim 11, wherein the carbon is washed with an acid to remove the metal.

13. Mesoporous carbon produced by a method as claimed in claim 1.

14. A smoking article comprising smoking material and mesoporous carbon produced by a method as claimed in claim 1.

15. A smoke filter comprising mesoporous carbon produced by a method as claimed in claim 1.

16. The method as claimed in claim 1, wherein the mesoporous carbon contains a micropore volume of at least 0.4 cm³/g and a mesopore volume of at least 0.3 cm³/g.

17. Mesoporous carbon as claimed in claim 13, wherein the mesoporous carbon contains a micropore volume of at least 0.4 cm³/g and a mesopore volume of at least 0.3 cm³/g.

18. The smoke filter as claimed in claim 15 wherein the mesoporous carbon contains a micropore volume of at least 0.4 cm³/g and a mesopore volume of at least 0.3 cm³/g.
